(19) United States
(12) Patent Application Publication
(10) Pub. No.: US 2004/0213258 A1
(43) Pub. Date: Oct. 28, 2004

(54) Implementing information technology management policies

(76) Inventor: Sundaresan Ramamoorthy, San Jose, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/423,539

(22) Filed: Apr. 25, 2003

(51) Int. Cl. H04L 12/28

(52) U.S. Cl. 370/395.1

(57) ABSTRACT

A method of implementing a policy of an information technology system. A requester group comprising a plurality of requesters with equal privileges under the policy is formed. A resource group comprising a plurality of resources to be accessed by the resource group subject to the policy is formed. The policy is implemented as the requestor group acting upon the resource group.

### TECHNICAL FIELD

Embodiments of the present invention relate to policy management of Information Technology Systems.

### BACKGROUND ART

Managing the operation of complex Information Technology (IT) Systems, e.g., a corporate IT infrastructure, generally entails establishing “rules” or “policies” governing such operation. For example, an IT system usually has an access policy stating who (or what) may have access to the system. It is typically inefficient or impractical for a person in charge of an IT system to specify, e.g., by name, everyone who is to be allowed access to the IT system. Rather, typical policies are more general in nature. For example, a typical access policy may be to allow all company employees access, and other groups, e.g., partners, are allowed access only as approved by the director.

There are usually numerous policies to be set, implemented and maintained in the course of constructing and operating an IT system. Generally, policies have been grouped into three groups or “levels” of policies: Operating System (OS) Policies, Network Policies and Application Policies. Operating System Policies may include which versions of various operating systems are supported and a password policy, e.g., passwords must be at least six characters long and include a number. Examples of Network policies include firewall policies, virtual private network (VPN) policies, router rules, quality of service (QOS) policies and the like. Application policies may include access policies, e.g., who may access a particular application, e.g., a web browser, storage policies, e.g., all information created and accessed by an application will be stored in an encrypted form, and the like. It is to be appreciated that there may be similar policies within different policy groups.

Conventionally, vendors supplying IT components, e.g., firewalls, routers, modems and the like, typically supply tools to configure those components. For example, a firewall supplier will generally supply a means to configure their firewalls. Likewise, a router supplier will generally supply a means to configure their routers. Some vendors may even supply automatic configuration tools that configure a set of components, e.g., all firewalls in an IT system, to implement one of a standard, e.g., predetermined by the vendor, set of firewall policies. Further, some software suppliers offer products that may partially implement a single policy, e.g., a password policy.

Unfortunately, no system of centralized policy definition and management is available.

Consequently, highly skilled network administrative personnel are required to interpret policy statements from executives and attempt to implement such policies on the wide variety of hardware devices and software systems that make up an information technology infrastructure. These network administrators typically are forced to use a variety of different tools corresponding to the various elements of the IT infrastructure to configure each different part of that infrastructure.

Because the implementation of policies is a manual process involving numerous steps, it is error prone. It is common for many skilled individuals to have somewhat different interpretations or understandings of a high level directive. Such differences may lead to different implementations within areas of control and/or influence of different individuals. This may lead to incompatibilities of function or erroneous attempts to implement a stated policy. Further, any given human-based implementation of a policy may suffer catastrophic failure when another person assumes responsibility for that implementation. For example, a subsequent work shift may modify configuration information for a component of a network infrastructure, e.g., while diagnosing a problem, and inadvertently violate a policy through lack of understanding.

Thus a need exists for a method and system to implement information technology management policies. A further need exists to meet the previously identified need in a manner that is complimentary and compatible with conventional computer system management techniques. In conjunction with the aforementioned needs, a still further need exists for implementing a policy of an information technology system wherein the policy comprises a substantially natural language statement.

### SUMMARY OF THE INVENTION

Embodiments of the present invention provide for a method and system to implement information technology management policies. Further embodiments of the present invention meet the previously identified need in a manner that is complimentary and compatible with conventional computer system management techniques. Still further embodiments of the present invention provide for implementing a policy of an information technology system wherein the policy comprises a substantially natural language statement.

A method of implementing a policy of an information technology system is disclosed. A requestor group comprising a plurality of requestors with equal privileges under the policy is formed. A resource group comprising a plurality of resources to be accessed by the resource group subject to the policy is formed. The policy is implemented as the requester group acting upon the resource group.

### BRIEF DESCRIPTION OF THE DRAWINGS

FIG. 1 illustrates a block diagram depicting implementation of an information system policy, according to an embodiment of the present invention.

FIG. 2 is a flow chart of a method of implementing a policy of an information technology system, according to an embodiment of the present invention.

FIG. 3 illustrates a flow chart of a method for implementing a policy of an information technology system wherein the policy comprises a substantially natural language statement, according to an embodiment of the present invention.

FIG. 4 illustrates a block diagram of an exemplary computer system upon which embodiments of the present invention can be implemented.

### BEST MODES FOR CARRYING OUT THE INVENTION

Consider an exemplary situation in which company “A” operates a highly complex information technology infrastructure. This infrastructure may be used, for example, to host a public access web site, to host a company intranet, to run accounting software, to process payroll, to serve hardware and software development activities and the like. In the course of business, company “A” decides to engage in a joint development activity with another entity, company “B.” It is further decided that the IT systems of company “A” will host certain aspects of the joint development project.

As a consequence of the joint project, a new policy should be implemented governing operation of company “A's” IT infrastructure. An exemplary policy may be stated in simple terms as, “Allow developers at company ‘B’ who are working on the joint project to access those (company ‘A’) IT resources necessary to complete the project.”

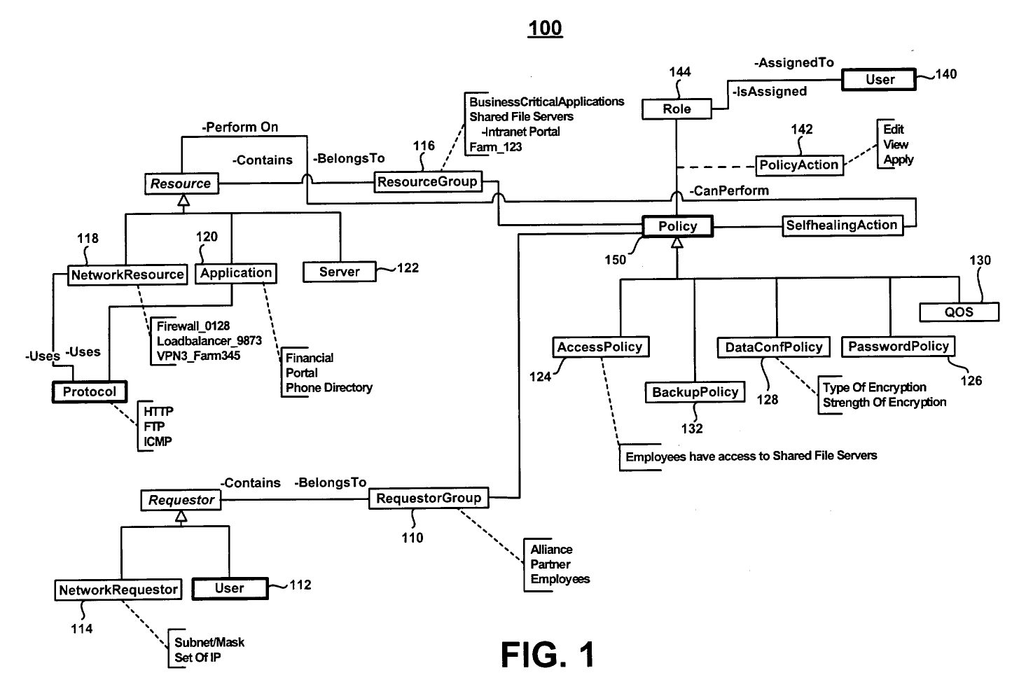

FIG. 1 illustrates a block diagram depicting implementation 100 of an information system policy, according to an embodiment of the present invention. Requestor group 110 represents those entities, for example, people (users) or computer processes, e.g., applications, which are to be affected by the policy, for example, “developers at company ‘B’ who are working on the joint project.” User 112, e.g., a developer at company “B,” has been identified as a user to be authorized. Typically, user 112 will access company “A's” IT systems from company “B's” infrastructure. Network requester 114 represents various network parameters, e.g., a subnet address, that may be associated with user 112's access of company “A's” IT systems. According to an embodiment of the present invention, user 112 may be prohibited from accessing company “A's” IT systems except when using particular IT systems belonging to user 112's employer. Requestor group 110 may generally take the form of a data structure in computer readable memory.

Resource group 116 represents those entities, e.g., networks, applications, servers and the like, to be affected by the new policy. Resource group 116 may comprise network resources 114, e.g., a firewall (hardware or software), application(s) 120, e.g., a computer aided design (CAD) program, and server 122. It is to be appreciated that many resources, of a wide variety of types, may be combined into a resource group such as resource group 116. Resource group 116 may generally take the form of a data structure in computer readable memory.

A somewhat more specific statement of the policy may be made in these terms: “Allow requestor group 110 to access resource group 116.” This policy may translate into a variety of implementation level details. The implementation of a policy may include an access policy, e.g. access policy 124, for applications. An access policy may further influence other areas of a network. For example, an access policy may require a firewall to be configured to allow particular internet protocol (IP) addresses through the firewall. In addition, an access policy may require certain applications, e.g., a CAD program, to allow project team members from company “B” access to the program and/or the program's data structures. Further, there may be Operating System (OS) implications of an access policy. For example, project team members from company “B” may require user accounts on certain of company “A's” computer systems.

There may be a pre-defined mapping of network elements, e.g., firewalls, routers, servers and the like. The IT systems will also typically comprise OS(es) and applications. When a policy is established, rules for each of the network elements should be created. According to an embodiment of the present invention, such rules may further generate specific configuration information for a variety of network elements, e.g., hardware and software. It is appreciated that there may be different kinds of similar elements. For example, a network may comprise firewall devices from different vendors requiring different details of configuration.

It is to be appreciated that numerous standard policies, e.g., due to regulatory requirements, exist and may be implemented as desired or required. If a standard policy does not exist, it may be created, for example, in extensible markup language (XML). An exemplary access policy standard well suited to embodiments of the present invention is “extensible Access Control Markup Language” (XACML), commercially available from the Organization for the Advancement of Structured Information Standards (OASIS).

Another type of common policy is a password policy, e.g., password policy 126. Password policy 126 should delineate various aspects of access passwords for an IT infrastructure, e.g., composition of passwords, which resources require password access, expiration and change policies for passwords.

Yet another type of policy is a data confidentiality policy, e.g., data confidentiality policy 128. A data confidentiality policy should delineate when encryption is required, e.g., in transmissions from company “A” to company “B,” or if data should be stored in an encrypted form. A data confidentiality policy should also specify the level of encryption necessary, e.g., triple DES with a 256 bit key. A data confidentiality policy may apply to a resource group, e.g., particular data sets or firewalls, to a requestor group, e.g., particular users and/or IP addresses, or combinations thereof.

Still another policy type is a quality of service (QOS) policy, e.g., quality of service policy 130. A QOS policy typically delineates performance levels, e.g., bandwidth, available storage, latency, etc., available to all users of an information technology infrastructure. It is appreciated that different users (or requestor groups) may have different quality of service levels.

Another policy type is a backup policy, e.g., backup policy 132. A backup policy typically delineates data sets to be stored for archival and/or restoration purposes. A backup policy usually also sets a schedule for performing backup operations. It is appreciated that different data sets may have different backup policies. For example, project design data may be backed up several times each day, e.g., to ensure that little critical work could be lost, while less critical information, e.g., company news reports, may be backed up less often.

Because of the variable importance that may be assigned to various data sets, a backup policy may typically comprise a plurality of backup policies (or sub policies) acting upon different resource groups representing different types of data sets. For example, design data may be grouped into a resource group in order to be backed up frequently, while data sets comprising company news may be grouped into a different resource group to be backed up less frequently (or not at all). A requester group for backup processes may be, e.g., a scheduled software process. The backup process may access a list of resource groups and associated backup schedules.

Role group 144 delineates those entities, e.g., a chief information officer or IT director, authorized to set a policy. A policy action, e.g., policy action 142, delineates a specific action upon a policy, e.g., edit, view or apply a policy. A policy administrator, e.g., user 140, represents the personnel authorized to take policy actions, e.g., to implement a policy generated by an authorized member of role group 144.

Policy implementation block 150 represents the actual implementation of at least one aspect of an information technology system policy. For example, an implementation of a policy can take the form of a configuring bit pattern, e.g., a configuration of a firewall device. It is appreciated that such a bit pattern is usually controlled by a software program which is typically specific to the type of device being configured. It is the responsibility of policy implementation block 150 to implement a policy a requestor group (or groups) acting upon a resource group (or groups), subject to various policy standards, e.g., access policy 124 and/or password policy 126.

Considering the exemplary policy statement from above, within policy implementation block 150, specific implementation actions should be taken as a requester group (or groups) acting upon a resource group (or groups), subject to various policy standards. For example, in order to allow user 112 to access portions of company “A's” information technology systems, a firewall device may have to be configured/reconfigured to allow such access. When the configuration of that firewall device is subsequently reviewed, e.g., to implement another information technology policy, the proposed configuration should be reviewed to ensure that it still implements the exemplary policy.

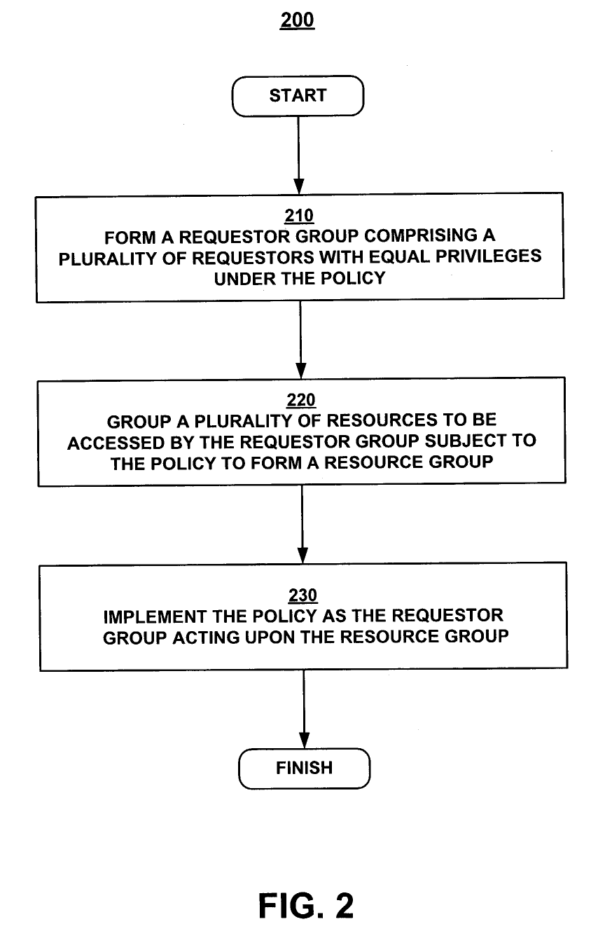

FIG. 2 is a flow chart of a method 200 of implementing a policy of an information technology system, according to an embodiment of the present invention. In block 210, a requester group comprising a plurality of requesters with equal privileges under the policy is formed. A requestor group is a collection of entities to be allowed access to various aspects of the information technology system. For example, a requestor may be an individual user, inside or external to the organization controlling the information technology system. Requestors may also be network entities, for example particular internet protocol (IP) addresses or ranges of IP addresses. The requesters should have equal privileges under the policy. For example, requestor “A” may be permitted unrestricted access to the information technology system. Only other requesters to be granted similar unrestricted access to the information technology system under the same policy should be grouped with requestor “A.”

Grouping requestors into a requestor group advantageously allows implementation decisions, e.g., a configuration setting in a firewall, to be made with respect to the requestor group. Under the conventional art, such implementation decisions were typically made piecemeal with respect to each individual requestor. It is to be appreciated that embodiments of the present invention are well suited to other types of requesters, and that such types of requestors may further be grouped into requester groups.

In block 220, a plurality of resources to be accessed by the requestor group subject to the policy is grouped to form a resource group. Similar to requester groups, a resource group is a collection of entities of an information technology system to be accessed by requestors.

According to embodiments of the present invention, resources may comprise a communications protocol. For example, it may be desirable to allow file transfer protocol (FTP) communications with an information technology system, while preventing hypertext transfer protocol (http) communications. A resource may also comprise an application software program. For example, it may be desirable to allow members of a design team access to a computer aided design (CAD) tool program. It is to be appreciated that embodiments of the present invention are well suited to other types of resources.

Resources may also comprise various well known networking devices and/or software, including, for example, software firewalls and firewall devices and routers, switches and the like. Resources may further comprise a data set stored on computer readable media. For example, users of a computer aided design (CAD) tool program should be given access to associated data sets. Other users, however, may be advantageously restricted from accessing such data sets.

Resources may further comprise computing resources, for example, a server computer system. For example, it may be desirable to control access to a server hosting a company's financial information database.

In block 230, the policy is implemented as the requestor group acting upon the resource group. For example, a requester group may include a specific user. To perform an assignment, the user may require access to a particular data set, e.g., CAD data. By allowing the user access to the CAD data, at least a portion of the policy is implemented, according to an embodiment of the present invention.

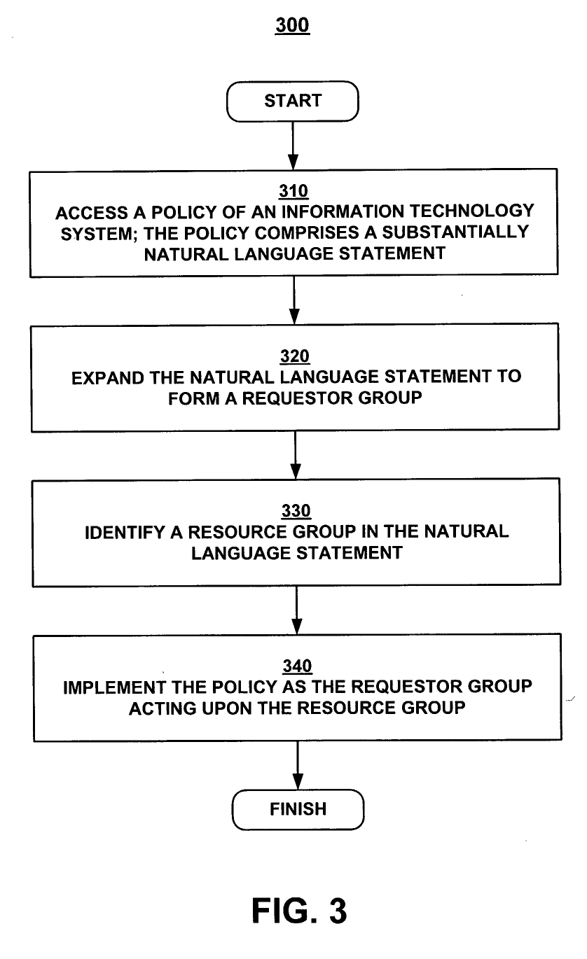

FIG. 3 illustrates a flow chart of a method 300 for implementing a policy of an information technology system wherein the policy comprises a substantially natural language statement, according to an embodiment of the present invention. Information technology policies typically are expressed by high level members of an organization, e.g., a chief information officer (CIO) or an information technology director, in a natural language statement. It is conventionally very complex and error prone to implement such a statement.

In block 310, a policy of an information technology system comprising a substantially natural language statement is accessed. For example, a CIO may make the statement, “Allow developers at company ‘B’ who are working on the joint project to access those (company ‘A’) IT resources necessary to complete the project.”

In block 320, the natural language statement is expanded to form a requestor group. At a high level, the group may be identified, as per the present example, as “developers at company ‘B’ who are working on the joint project.” This can be further expanded, for example, to form a list of those specific individuals at company “B” assigned to the project. Additionally, internet protocol addresses associated with those specific individuals may further be included in the requestor group.

In block 330, a resource group in the natural language statement is identified. For example, “IT resources necessary to complete the project.” Such IT resources may comprise particular servers, data sets, application programs, e.g., a CAD program, communication protocols and the like.

In block 340, the policy is implemented as the requestor group acting upon the resource group. For example, when ever a configuration of a network element, e.g., a firewall device, is adjusted, the proposed configuration should be tested against the policy. Typically, there will be numerous policies in effect, and a proposed configuration should be tested against all such policies. With the present example, prior to adjusting a firewall device, the proposed configuration should be examined to determine if the above requestor group may access the group of resources under the proposed configuration. If not, the proposed configuration should not be implemented.

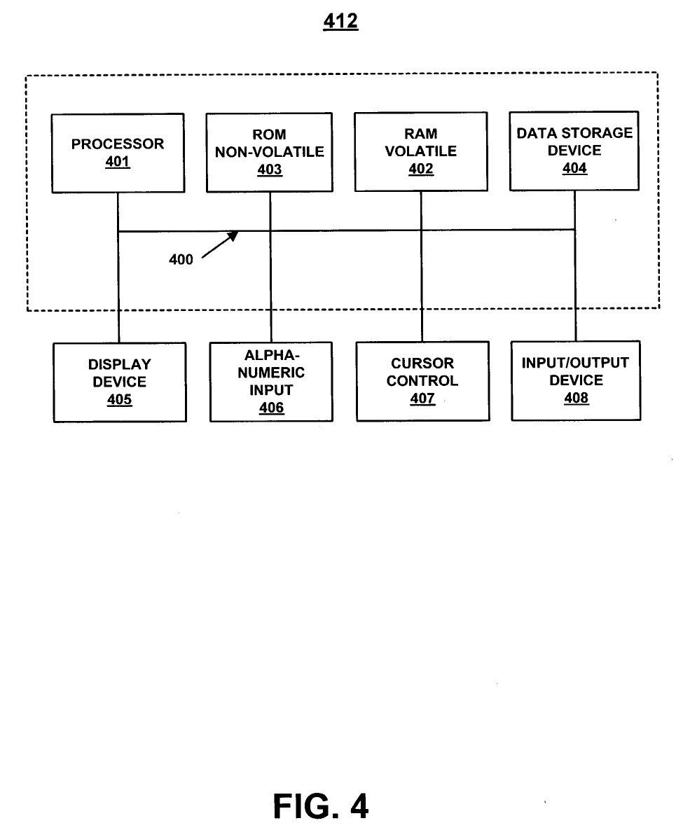

FIG. 4 illustrates a block diagram of an exemplary computer system 412 upon which embodiments of the present invention can be implemented. It is to be appreciated that other computer systems with differing configurations can also be used in place of computer system 412 within the scope of the present invention.

Computer system 412 includes an address/data bus 400 for communicating information, a central processor 401 coupled with bus 400 for processing information and instructions; a volatile memory unit 402 (e.g., random access memory [RAM], static RAM, dynamic RAM, etc.) coupled with bus 400 for storing information and instructions for central processor 401; and a non-volatile memory unit 403 (e.g., read only memory [ROM], programmable ROM, flash memory, EPROM, EEPROM, etc.) coupled with bus 400 for storing static information and instructions for processor 401. Computer system 412 can also contain an optional display device 405 coupled to bus 400 for displaying information to the computer user. Moreover, computer system 412 also includes a data storage device 404 (e.g., disk drive) for storing information and instructions.

Also included in computer system 412 is an optional alphanumeric input device 406. Device 406 can communicate information and command selections to central processor 401. Computer system 412 also includes an optional cursor control or directing device 407 coupled to bus 400 for communicating user input information and command selections to central processor 401. Computer system 412 also includes signal communication interface (input/output device) 408, which is also coupled to bus 400, and can be a serial port. Communication interface 408 can also include wireless communication mechanisms.

Embodiments of the present invention provide for a method and system to implement information technology management policies. Further embodiments of the present invention meet the previously identified need in a manner that is complimentary and compatible with conventional computer system management techniques. Still further embodiments of the present invention provide for implementing a policy of an information technology system wherein the policy comprises a substantially natural language statement.

Embodiments of the present invention, implementing information technology management policies, are thus described. While the present invention has been described in particular embodiments, it should be appreciated that the present invention should not be construed as limited by such embodiments, but rather construed according to the below claims.

What is claimed is:

1. A method of implementing a policy of an information technology system comprising:
forming a requestor group comprising a plurality of requestors with equal privileges under said policy;
grouping a plurality of resources to be accessed by said requestor group subject to said policy to form a resource group; and
implementing said policy as said requestor group acting upon said resource group.

2. The method of claim 1 wherein said requestor group comprises an internet protocol address.

3. The method of claim 1 wherein said requestor group comprises information identifying a specific user.

4. The method of claim 1 wherein said resource group comprises a communications protocol.

5. The method of claim 1 wherein said resource group comprises an application software program.

6. The method of claim 1 wherein said resource group comprises a firewall device.

7. The method of claim 1 wherein said resource group comprises a network router.

8. The method of claim 1 wherein said resource group comprises a data set stored on computer readable media.

9. The method of claim 1 wherein said resource group comprises a server computer system.

10. The method of claim 1 wherein said policy comprises an access policy.

11. The method of claim 1 wherein said resource group comprises a data confidentiality policy.

12. The method of claim 1 wherein said resource group comprises a password policy.

13. The method of claim 1 wherein said resource group comprises a backup policy.

14. The method of claim 1 wherein said resource group comprises a quality of service policy.

15. A computer-usable medium having computer-readable program code embodied therein for causing a computer system to perform a method, said method comprising:
accessing a policy of an information technology system, wherein said policy comprises a substantially natural language statement;
expanding said natural language statement to form a requestor group comprising a plurality of requesters with equal privileges under said policy;
identifying a resource group in said natural language statement, said resource group comprising a plurality of resources to be accessed by said requester group subject to said policy; and
implementing said policy as said requestor group acting upon said resource group.

16. The computer-usable medium of claim 15 wherein said requestor group comprises an internet protocol address.

17. The computer-usable medium of claim 15 wherein said requestor group comprises information identifying a specific user.

18. The computer-usable medium of claim 15 wherein said resource group comprises an application software program.

19. The computer-usable medium of claim 15 wherein said resource group comprises a network router.

20. The computer-usable medium of claim 15 wherein said resource group comprises a data set stored on computer readable media.
